(19) United States
(12) Patent Application Publication
(10) Pub. No.: US 2010/0172682 A1
(43) Pub. Date: Jul. 8, 2010

(54) TAPE DRIVE

(76) Inventor: Philip Hart, Nottingham (GB)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 12/602,222

(22) PCT Filed: May 29, 2008
(86) PCT No.: PCT/GB2008/001831

§ 371 Date: Nov. 30, 2009

Related U.S. Application Data
(60) Provisional application No. 60/951,836, filed on Jul. 25, 2007.

(30) Foreign Application Priority Data
May 31, 2007 (GB) 0710363.3

(51) Int. Cl. B41J 33/14

(52) U.S. Cl. 400/223; 400/234

(57) ABSTRACT

A printing apparatus configured to carryout a plurality of printing operations. The apparatus comprises a tape drive comprising two motors, two tape spool supports on which spools of tape may be mounted, each spool being drivable by a respective one of said motors, and a controller for controlling the energisation of the motors such that the tape may be transported in at least one direction between spools mounted on the of a characteristic of said tape, the characteristic being affected by operation of the tape drive, determine whether said value satisfies a predetermined criterion, and if said value does not satisfy said predetermined criterion, to provide a predetermined control signal, said predetermined control signal being configured to affect said characteristic of said tape.

### CROSS-REFERENCE TO RELATED APPLICATIONS

This application is the U.S. National Stage of International Application No. PCT/GB2008/001831 filed May 29, 2008, and claims the benefit thereof. The International Application claims the benefit of Great Britain Application No. 0710363.3 filed May 31, 2007, and U.S. Provisional Application No. 60/951,836 filed Jul. 25, 2007, both of which are incorporated herein by reference in their entirety.

### BACKGROUND OF THE INVENTION

The present invention relates to a tape drive. Such a tape drive may form part of printing apparatus. In particular, such a tape drive may be used in transfer printers, that is printers which make use of carrier-supported inks.

In transfer printers, a tape which is normally referred to as a printer tape and carries ink on one side is presented within a printer such that a printhead can contact the other side of the tape to cause the ink to be transferred from the tape on to a target substrate of, for example, paper or a flexible film. Such printers are used in many applications. Industrial printing applications include thermal transfer label printers and thermal transfer coders which print directly on to a substrate such as packaging materials manufactured from flexible film or card.

Ink tape is normally delivered to the end user in the form of a roll wound onto a core. The end user pushes the core on to a tape spool, pulls a free end of the roll to release a length of tape, and then engages the end of the tape with a further spool. The spools may be mounted on a cassette, which can be readily mounted on a printing machine. The printing machine includes a transport means for driving the spools, so as to unwind tape from one spool and to take up tape on the other spool. The printing apparatus transports tape between the two spools along a predetermined path past the printhead.

Known printers of the above type rely upon a wide range of different approaches to the problem of how to drive the tape spools. Some rely upon stepper motors operating in a position control mode to pay out or take-up a predetermined quantity of tape. Other known printers rely on DC motors operating in a torque mode to provide tension in the tape and to directly or indirectly drive the spools. Some known arrangements drive only the spool on to which tape is taken up (the take-up spool) and rely upon some form of “slipping clutch” arrangement on the spool from which tape is drawn (the supply spool) to provide a resistive drag force so as to ensure that the tape is maintained in tension during the printing and tape winding processes and to prevent tape overrun when the tape is brought to rest. It will be appreciated that maintaining adequate tension is an essential requirement for the proper functioning of the printer.

Alternative forms of known printer tape drives drive both the take-up spool and the supply spool. A supply spool motor may be arranged to apply a predetermined drag to the tape, by being driven in the reverse direction to the direction of tape transport. In such an arrangement (referred to herein as “pull-drag”), the motor connected to the take-up spool is arranged to apply a greater force to the tape than the motor connected to the supply spool such that the supply spool motor is overpowered and the supply spool thus rotates in the direction of tape transport. The supply spool drag motor keeps the tape tensioned in normal operation.

In a further alternative arrangement a supply spool motor may be driven in the direction of tape transport such that it contributes to driving the tape from the supply spool to the take-up spool. Such an arrangement is referred to herein as “push-pull”. The take-up motor pulls the tape onto the take-up spool as tape is unwound by the supply spool motor such that tape tension is maintained. Such a push-pull arrangement is described in our earlier UK patent number GB 2369602, which discloses the use of a pair of stepper motors to drive the supply spool and the take-up spool. In GB 2369602 a controller is arranged to control the energisation of the motors such that the tape may be transported in both directions between spools of tape. The tension in the tape being transported between spools is monitored and the motors are controlled to energise both motors to drive the spools of tape in the direction of tape transport.

As a printer gradually uses a roll of tape, the outer diameter of the supply spool decreases and the outer diameter of the take-up spool increases. In slipping clutch arrangements, which offer an essentially constant resistive torque, the tape tension will vary in proportion to the diameter of the supply spool. Given that it is desirable to use large supply spools so as to minimise the number of times that a tape roll has to be replenished, this is a serious problem particularly in high-speed machines where rapid tape transport is essential. For tape drives that use both a take-up motor and a supply spool motor, the variation in spool diameters can make it difficult to determine the correct drive signal to be supplied to each motor such that tape tension is maintained, and/or that tape is unwound or rewound at the correct rate.

Given these constraints, known printer designs offer a compromise in performance by way of limiting the rate of acceleration, the rate of deceleration, or the maximum speed capability of the tape transport system. Overall printer performance has, as a result, been compromised in some cases.

Known tape drive systems generally operate in one of two manners, that is either continuous printing or intermittent printing. In both modes of operation, the apparatus performs a regularly repeated series of printing cycles, each cycle including a printing phase during which ink is being transferred to a substrate, and a further non-printing phase during which the apparatus is prepared for the printing phase of the next cycle.

In continuous printing, during the printing phase a stationary printhead is brought into contact with a printer tape the other side of which is in contact with a substrate on to which an image is to be printed. The term “stationary” is used in the context of continuous printing to indicate that although the printhead will be moved into and out of contact with the tape, it will not move relative to the tape path in the direction in which tape is advanced along that path. During printing, both the substrate and tape are transported past the printhead, generally but not necessarily at the same speed.

Generally only relatively small lengths of the substrate which is transported past the printhead are to be printed upon, and therefore to avoid gross wastage of tape it is necessary to reverse the direction of travel of the tape between printing operations. Thus in a typical printing process in which the substrate is travelling at a constant velocity, the printhead is extended into contact with the tape only when the printhead is adjacent to regions of the substrate to be printed. Immediately before extension of the printhead, the tape must be accelerated up to, for example, the speed of travel of the substrate. The tape speed must then be maintained at the constant speed of the substrate during the printing phase and, after the printing phase has been completed, the tape must be decelerated and then driven in the reverse direction so that the used region of the tape is on the upstream side of the printhead.

As the next region of the substrate to be printed approaches, the tape must then be accelerated back up to the normal printing speed and the tape must be positioned so that an unused portion of the tape close to the previously used region of the tape is located between the printhead and the substrate when the printhead is advanced to the printing position. Thus very rapid acceleration and deceleration of the tape in both directions is required, and the tape drive system must be capable of accurately locating the tape so as to avoid a printing operation being conducted when a previously used portion of the tape is interposed between the printhead and the substrate.

In intermittent printing, a substrate is advanced past a printhead in a stepwise manner such that during the printing phase of each cycle the substrate and generally but not necessarily the tape, are stationary. Relative movement between the substrate, tape and printhead are achieved by displacing the printhead relative to the substrate and tape. Between the printing phase of successive cycles, the substrate is advanced so as to present the next region to be printed beneath the printhead, and the tape is advanced so that an unused section of tape is located between the printhead and the substrate. Once again rapid and accurate transport of the tape is necessary to ensure that unused tape is always located between the substrate and printhead at a time that the printhead is advanced to conduct a printing operation.

The requirements of high speed transfer printers in terms of tape acceleration, deceleration, speed and positional accuracy are such that many known drive mechanisms have difficulty delivering acceptable performance with a high degree of reliability. Similar constraints also apply in applications other than high-speed printers, for instance drives used in labelling machines, which are adapted to apply labels detached from a label web. Tape drives in accordance with embodiments of the present invention are suitable for use in labelling machines in which labels are detached from a continuous label web which is transported between a supply spool and a take-up spool.

Our earlier UK Patent No. GB2,369,602 describes methods for control of the motors in a tape drive suitable for use in a thermal transfer printer. The described tape drive uses two stepper motors which each drive a respective tape spool. Both stepper motors are energised in the direction of tape transport. It is described that tension in the tape is maintained by calculating a length of tape to be added to or subtracted from tape extending between the spools, and controlling the motors to add or subtract the calculated length of tape.

### BRIEF DESCRIPTION OF THE INVENTION

It is an object of embodiments of the present invention to obviate or mitigate one or more of the problems associated with the prior art, whether identified herein or elsewhere. It is a further object of embodiments of the present invention to provide a tape drive which can be used to deliver printer tape in a manner which is capable of meeting the requirements of high speed production lines, although the tape drive of the present invention may of course be used in any other application where similar high performance requirements are demanded.

According to a first aspect of the present invention, there is provided a printing apparatus configured to carryout a plurality of printing operations. The apparatus comprises a tape drive comprising two motors, two tape spool supports on which spools of tape may be mounted, each spool being drivable by a respective one of said motors, and a controller for controlling the energisation of the motors such that the tape may be transported in at least one direction between spools mounted on the spool supports. The controller is configured to:

(a) receive a signal indicative of a value of a characteristic of said tape, the characteristic being affected by operation of the tape drive;

(b) determine whether said value satisfies a predetermined criterion; and

(c) if said value does not satisfy said predetermined criterion, to provide a predetermined control signal, said predetermined control signal being configured to affect said characteristic of said tape.

In this way, the controller provides a predetermined control signal when the characteristic of the tape does not satisfy the predetermined criterion. The provided control signal is predetermined, obviating the need for calculation of a correction to be applied. The control signal is predetermined in the sense that its value is determined before it is determined whether the value of the characteristic of the tape satisfies said predetermined criterion. The characteristic of the tape may be a characteristic of the tape governed by transport of the tape between the spools. For example, the characteristic may be governed by the way in way in which the motors are driven. The characteristic may be tension in the tape, or a path length between the spools.

The controller may be configured to carry out steps (a) to (c) a plurality of times. In this way the controller may carry out a number of iterations. The controller may be configured to carry out steps (a) to (c) until said value satisfies said predetermined criterion, although the controller may be configured to carry out steps (a) to (c) not more than a predetermined plurality of times or for not more than a predetermined time period. The controller may be configured to carry out steps (a) to (c) a plurality of times between two successive printing operations. The processing of steps (a) to (c) is preferably carried out when the tape is stationary, although in some embodiments is carried out while the tape is moving. The processing can conveniently be carried out between printing operations, while the tape is either moving or stationary.

The printing apparatus may further comprise a sensor configured to generate said signal. The sensor may comprise a deflectable element deflectable by said tape, and said signal may be generated based upon deflection of said deflectable element. Deflection of the delectable element may be monitored by an analogue sensor proving a variable output indicative of a degree of deflection of the deflectable element. The sensor may further comprise a Hall effect sensor. The Hall effect sensor may be an analogue Hall effect sensor providing an output which indicates a degree of deflection of the deflectable element. The deflectable element may be provided with at least one magnetic element and deflection of the deflectable element may be monitored based upon an effect of said at least one magnetic element on said Hall effect sensor. The sensor may comprise at least one switch, and said signal may be generated based upon activation of said at least one switch. The said sensor may comprise a plurality of switches, and said signal may be generated based upon activation of said plurality of switches. The sensor may comprise a loadcell.

At least one of said motors may be a position controlled motor. At least one of said motors may be a stepper motor.

The predetermined control signal may control at least one of said motors to turn through a predetermined number of steps. The predetermined control signal may control at least one of said motors to add or subtract a predetermined length of tape to or from tape extending between the spools. The apparatus may further comprise means to calculate a number of steps through which at least one of said motors is to be turned to add or subtract said predetermined length.

The controller may be operative to energise both motors to drive the spools of tape in the direction of tape transport. The controller may be configured to maintain tension in tape between said spools between predetermined limits. The controller may be arranged to control the motors to transport tape in both directions between the spools.

The printing apparatus may be a thermal transfer printing apparatus. The tape drive may be configured to transport inked tape between said spools. The apparatus may comprise a printhead configured to contact said tape between said spools.

The tape drive may be incorporated in a transfer printer for transferring ink from a printer tape to a substrate, which is transported along a predetermined path adjacent to the printer. The tape drive acts as a printer tape drive mechanism for transporting ink ribbon between first and second tape spools, and the printer further comprising a printhead arranged to contact one side of the ribbon to press an opposite side of the ribbon into contact with a substrate on the predetermined path. There may also be provided a printhead drive mechanism for transporting the printhead along a track extending generally parallel to the predetermined substrate transport path (when the printer is operating in an intermittent printing mode) and for displacing the printhead into and out of contact with the tape. A controller controls the printer ink ribbon and printhead drive mechanisms, the controller being selectively programmable either to cause the ink ribbon to be transported relative to the predetermined substrate transport path with the printhead stationary and displaced into contact with the ink ribbon during printing, or to cause the printhead to be transported relative to the ink ribbon and the predetermined substrate transport path and to be displaced into contact with the ink ribbon during printing.

The drive mechanism may be bi-directional such that tape may be transported from a first spool to a second spool and from the second spool to the first. Typically, unused tape is provided in a roll of tape mounted on the supply spool. Used tape is taken up on a roll mounted on the take-up spool. However, as described above, in order to prevent gross ribbon wastage, after a printing operation the tape can be reversed such that unused portions of the tape may be used before being wound onto the take-up spool.

### BRIEF DESCRIPTION OF THE DRAWINGS

Embodiments of the present invention will now be described, by way of example, with reference to the accompanying drawings in which:

FIG. 1 is a schematic illustration of a printer tape drive system in accordance with an embodiment of the present invention;

FIG. 2 is a schematic illustration of a printer tape drive system in accordance with an alternative embodiment of the present invention;

FIG. 3 is a schematic illustration of two tape-spools used in the tape drive systems of FIGS. 1 and 2; and

FIG. 4 is a flowchart of processing carried out in an embodiment of the present invention.

### DETAILED DESCRIPTION OF THE INVENTION

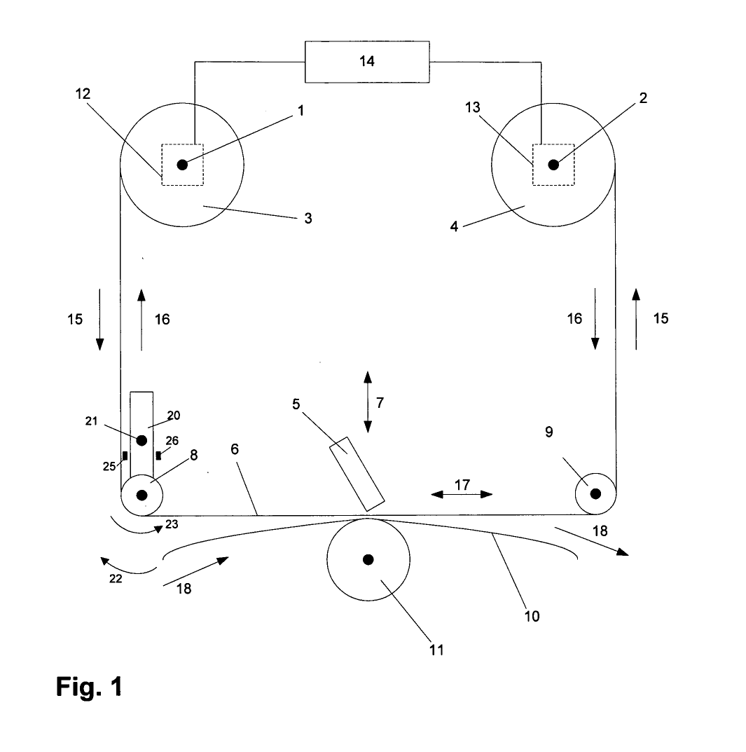

Referring to FIG. 1, this schematically illustrates a tape drive in accordance with the present invention suitable for use in a thermal transfer printer. First and second shafts 1, 2 support a supply spool 3 and a take-up spool 4 respectively. The supply spool 3 is initially wound with a roll of unused tape, and the take-up spool 4 initially does not carry any tape. As tape is used, used portions of the tape are transported from the supply spool 3 to the take-up spool 4. A displaceable printhead 5 is provided, displaceable relative to tape 6 in at least a first direction indicated by arrow 7. Tape 6 extends from the supply spool 3 around rollers 8, 9 to the take-up spool 4. The path followed by the tape 6 between the rollers 8 and 9 passes in front of the printhead 5. When printing is to take place, a substrate 10 upon which print is to be deposited is brought into contact with the tape 6 between rollers 8 and 9, the tape 6 being interposed between the printhead 5 and the substrate 10. The substrate 10 may be brought into contact with the tape 6 against a platen roller 11.

The supply shaft 1 is driven by a supply motor 12 and the take-up shaft 2 is driven by a take-up motor 13. The supply and take-up motors 12, 13 are illustrated in dashed outline, indicating that they are positioned behind the supply and take-up spools 3, 4. It will however be appreciated that in alternative embodiments of the invention, the spools are not directly driven by the motors. Instead the motor shafts may be operably connected to the respective spools by a belt drive or other similar drive mechanism.

A controller 14 controls the operation of motors 12, 13 as described in greater detail below. The supply and take-up motors 12, 13 are capable of driving the tape 6 in both directions. Tape movement may be defined as being in the print direction if the tape is moving from the supply spool 3 to the take-up spool 4, as indicated by arrows 15. When tape is moving from the take-up spool 4 to the supply spool 3, the tape may be considered to be moving in the tape reverse direction, as indicated by arrows 16.

When the printer is operating in continuous mode the printhead 5 will be moved into contact with the tape 6 when the tape 6 is moving in the print direction 15. Ink is transferred from the tape 6 to the substrate 10 by the action of the printhead 5. Tape movement may be reversed such that unused portions of the tape 6 are positioned adjacent to the printhead 5 before a subsequent printing operation is commenced.

In the configuration illustrated in FIG. 1, the spools 3, 4 are wound in the same sense as one another and thus rotate in the same rotational direction to transport the tape. Alternatively, the spools 3, 4 may be wound in the opposite sense to one another, and thus must rotate in opposite directions to transport the tape.

As described above, the printer schematically illustrated in FIG. 1 can be used for both continuous and intermittent printing applications. The controller 14 is selectively programmable to select either continuous or intermittent operation. In continuous applications, the substrate 10 will be moving continuously. During a printing cycle, the printhead 5 will be stationary but the tape will move so as to present fresh tape to the printhead 5 as the cycle progresses. In contrast, in intermittent applications, the substrate 10 is stationary during each printing cycle, the necessary relative movement between the substrate 10 and the printhead 5 being achieved by moving the printhead 5 parallel to the tape 6 and substrate 10 in the direction of arrow 17 during the printing cycle. In such a case, the roller 11 is replaced with a flat print platen (not shown) against which the printhead 5 presses the ribbon 6 and substrate 10. In both applications, it is necessary to be able to rapidly advance and return the tape 6 between printing cycles so as to present fresh tape to the printhead and to minimise tape wastage. Given the speed at which printing machines operate, and that fresh tape 6 should be present between the printhead 5 and substrate 10 during every printing cycle, it is necessary to be able to accelerate the tape 6 in both directions at a high rate and to accurately position the tape relative to the printhead. In the arrangement shown in FIG. 1 it is assumed that the substrate 10 will move only to the right as indicated by arrows 18. However, the apparatus can be readily adapted to print on a substrate travelling to the left (that is, in the opposite direction) in FIG. 1.

The driving of tape between the supply spool 3 and the takeup spool 4 is now described in further detail. In preferred embodiments of the invention, both the supply motor 12 and the takeup motor 13 are position-controlled motors.

A position-controlled motor is a motor controlled by a demanded output position. That is, the output position may be varied on demand, or the output rotational velocity may be varied by control of the speed at which the demanded output rotary position changes.

An example of a position-controlled motor is a stepper motor. A stepper motor is an example of an open loop position-controlled motor. That is, it is supplied with an input signal relating to a demanded rotational position or rotational velocity, the stepper motor being driven to achieve the demanded position or velocity. A stepper motor may also be provided with an encoder providing a feedback signal indicative of the actual output position or velocity. The feedback signal may be used to generate an error signal by comparison with the demanded output rotary position, the error signal being used to drive the motor to minimise the error. A stepper motor provided with an encoder in this manner comprises a closed loop form of position-controlled motor.

An alternative form of closed loop position-controlled motor comprises a torque-controlled motor (e.g. a DC motor) provided with an encoder. A torque-controlled motor is a motor that is controlled by a demanded output torque. The output from the encoder provides a feedback signal from which an error signal can be generated when the feedback signal is compared to a demanded output rotary position, the error signal being used to drive the motor to minimise the error.

In the present context the term “DC motor” is to be interpreted broadly as including any form of motor that can be driven to provide an output torque, such as a brushless DC motor, a brushed DC motor, an induction motor or an AC motor. A brushless DC motor comprises any form of electronically commutated motor with a commutation sensor. Similarly, the term stepper motor is to be interpreted broadly as including any form of motor that can be driven by a signal indicating a required change of rotary position.

An encoder is any form of angular position sensing device, such as an optical encoder, magnetic encoder, resolver, capacitive encoder or any other form of position sensing device. An encoder may be connected to an output shaft of a motor and used to provide a feedback signal indicating the angular position or motion of the motor output shaft.

When tape is driven between the supply spool 3 and the takeup spool 4 the controller operates to maintain tension in the tape within workable limits. In general terms tension in tape travelling between the supply spool 3 and the take-up spool 4 is monitored and the supply motor 12 and the take-up motor 13 are controlled by the controller 14 so as to maintain tape tension between predetermined limits.

In the embodiment of the invention shown in FIG. 1, tape passes around the roller 8 which is mounted on a body 20. The body 20 is rotatable about a pivot 21. A variable-force spring biases the body in a clockwise direction as indicated by an arrow 22. As tension in the tape increases, the roller 8 is urged in a direction indicated by an arrow 23 causing the body 20 to rotate about the pivot 21 in an anti-clockwise direction against the spring force. Movement of the body 20 is used so as to provide a signal indicative of deflection of the roller 8, and consequently indicative of tension in the tape.

In the embodiment shown in FIG. 1, movement of the body 20 activates two switches 25, 26 indicating that the body 20 has reached one of its extremes of travel.

Alternatively, the body 20 may be provided with magnets (not shown). A Hall effect sensor may be mounted such that movement of the body 20 (and consequently movement of the magnets) is detected by the Hall effect sensor. In this way, the Hall effect sensor generates a signal indicative of movement of the body 20. More specifically, the Hall effect sensor is an analogue sensor providing an output indicative of a degree of deflection of the body 20.

Movement of the body 20 can alternatively by monitored by providing the pivot 21 with an encoder arranged to monitor deflection of the body 20 about the pivot 21. Any suitable encoder can be used, and examples of such encoders are provided in the preceding description.

In the embodiment of the invention described above, the use of a variable force spring means that movement of the body 20 is indicative of a change of tension in the tape. In this way, monitoring of movement of the body 20 constitutes monitoring of tension in the tape. If however the variable force spring were replaced with a biasing means such that tension will not vary as the body 20 is deflected, monitoring of movement of the body 20 effectively constitutes monitoring of a length of tape path between the supply spool 3 and the take up spool 4. That is, where the biasing means is a constant force spring, deflection of the body 20 does not cause any change in tension in the tape. For example, where a constant force spring is used to bias the body, the spring may be such that movement of the body 20 can be achieved relatively easily any without any increase in tension in the tape. In such a case, movement of the body 20 does not represent any change in tension in the tape.

In general terms, where deflection of the body 20 is used to obtain a signal indicative of tension, the body 20 may be provided with limited travel (e.g. of the order of 1 mm). The body is biased by a variable force spring such that substantial measurable changes in tension in the tape produce negligible changes in path length. On the other hand where deflection of the body is used to obtain a signal indicative of path length between the supply spool 3 and the take up spool 4, the body 20 may be provided with greater travel and be biased using a constant force spring. In such an arrangement substantial, measurable changes in path length have a negligible effect on tension in the tape.

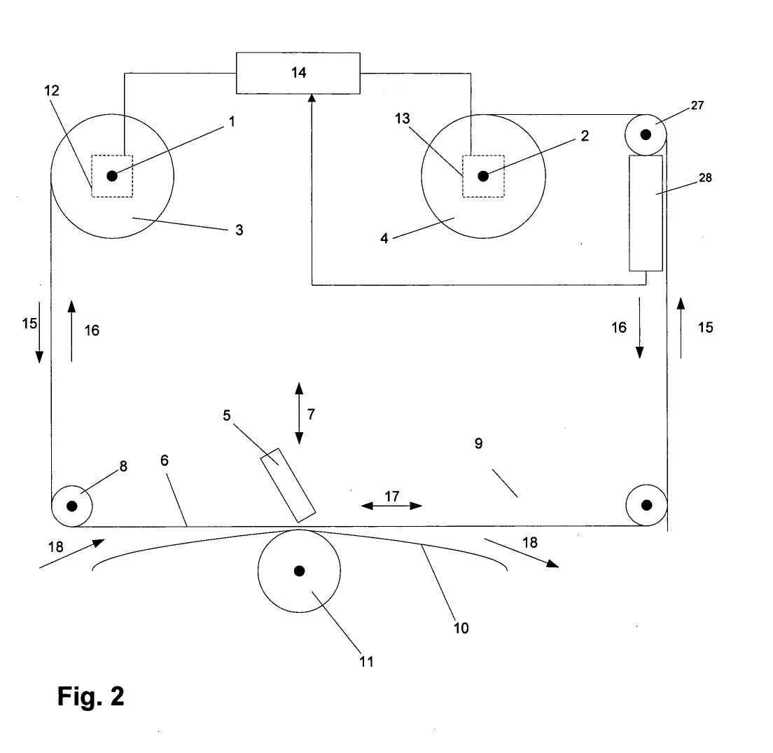

In alternative embodiments of the invention, tension in the tape being transported is monitored in different ways. For example, FIG. 2 shows an alternative embodiment of the invention, where like reference numerals indicate components which correspond to components of the embodiment shown in FIG. 1. Here, the tape passes around a roller 27 which bears against a loadcell 28. In this way, the output of the loadcell which is provided to the controller 14 is indicative of the force applied to the loadcell 28 by the roller 27, and consequently indicative of tension in the tape being transported.

In alternative embodiments of the invention, signals are derived directly from the motors to provide an indication of tape tension. A method for obtaining an indication of tape tension in this way is described in our earlier UK Patent GB 2,369,602, the contents of which are herein incorporated by reference.

In general operation of the embodiments of the invention described above with reference to FIGS. 1 and 2, the supply spool motor 12 and takeup spool motor 13 are both energised in the direction in which tape is to be transported. It will be appreciated that the nature of control signals provided to the supply spool motor 12 and takeup spool motor 13 will be dependent upon the diameters of the spools of tape. Specifically, it is desired that the supply spool motor 12 is controlled to pay out a predetermined quantity of tape while the takeup spool motor 13 is controlled to takeup the predetermined quantity of tape. Given that the diameters of supply spool 3 and takeup spool 4 vary as tape is transferred, it will be appreciated that control signals provided to the motors must similarly vary.

Diameters of the supply spool 3 and the takeup spool 4 can be determined in any convenient way. For example, one known method of monitoring the diameter of a spool of tape is based upon optical sensing comprising at least one emitter and detector pair. The emitter and detector pair is arranged such that as the diameter of the spool changes, the spool blocks that signal from the emitter to the detector, which may be detected. Such an optical spool diameter monitoring technique is disclosed in our earlier UK Patent No. GB 2369602, the contents of which are herein incorporated by reference.

An alternative method for determining tape spool diameter is disclosed in GB 2298821. Here, tape is passed around an idler roller of known diameter. The idler roller is provided with an anti-slip coating to prevent slippage occurring between the tape and the idler roller when the tape is moved. The outer diameter of the idler roller is known. Rotation of the idler roller is monitored. This is achieved by providing the idler roller with a magnetic disc having a north and south pole. Rotation of the idler roller can then be detected by an appropriate magnetic sensor. By detecting rotation of the idler roller of known diameter and knowing a number of steps through which a stepper motor has turned the diameter of a spool of tape associated with the stepper motor can be determined.

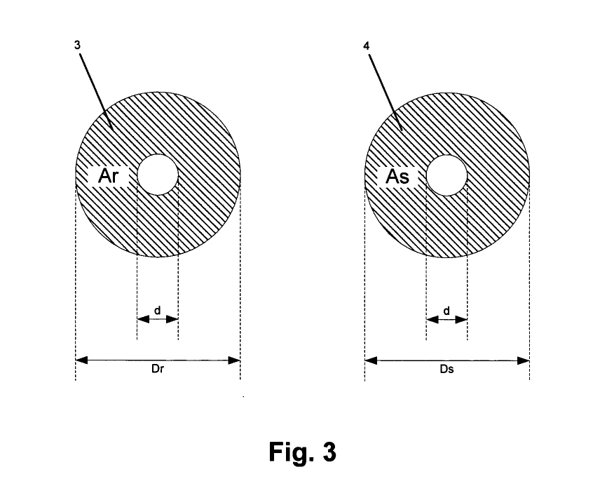

The foregoing description explains how initial spool diameters can be determined. FIG. 3 shows how spool diameters can be monitored on an ongoing basis.

Referring to FIG. 3, Aᵣ and Aₛ are the areas of spools 3, 4 respectively, d is the inner diameter of the spools and Dᵣ and Dₛ are the outer diameters of the spools at any given time. Hence:

Aᵣ+As=constant (1)

Aᵣ=π(Dᵣ/2)²−π(d/2)² (2)

A^{s}=π(D_{S}/2)²−π(d/2)² (3)

Substituting from (3) and (2) into (1) gives:

Dᵣ²+D_{S}²=constant=D_{rc}²+D_{sc}² (4)

Where D_{rc} and D_{sc} are rewind and supply spool diameters respectively at initial calibration time.

Current diameter ratio R=Dᵣ/Dₛ

Therefore rearranging this Dₛ=Dᵣ/R

And also Dᵣ=RD_{S}

Substituting in (4) gives:

$$\begin{matrix}{D}_{r}^{2} = {D}_{r}^{2} / {R}^{2} = {D}_{rc}^{2} + {D}_{SC}^{2} = {R}_{c}^{2} {D}_{sc}^{2} + {D}_{sc}^{2} \\ = {D}_{SC}^{2} ( {R}_{c}^{2} + 1 )\end{matrix}$$

where R_{c} is the ratio of rewind to the supply reel diameter at initial calibration.

Therefore Dᵣ²(R²+1)/R²=D_{sc}²(R_{c}²+1) and

Dᵣ²=[R²/(R²+1)] [D_{sc}²(R_{c}²+1)]

So, knowing the initial calibration spool diameters ratio (R_{c}), supply spool diameters ratio (R_{c}), supply spool diameter at calibration (D_{sc}) and the current spool diameters ratio (R), the current diameter of either or both spools Dᵣ or Dₛ can be derived.

In some applications it may be possible only to present a cassette carrying a substantially empty take-up spool and a substantially full supply spool of known outside diameter. In such circumstances it would not be necessary to determine the initial spool diameters. In general however it is much to be preferred to directly measure the spool diameters as it is likely that machine operators will at least on occasions use non-standard spool configurations (for example ribbon which has been partially used on an earlier occasion).

If monitoring of spool diameters is such as to allow accurate control signals to be determined such that the quantity of tape paid out by the supply spool 3 is equal to the quantity of tape take up by the takeup spool 4, it will be appreciated that tension in the tape (and path length in an arrangement having a variable path length) will remain substantially constant. In practice, however, such accurate control is not readily possible. It is therefore necessary to monitor tension (or path length) and control the motors to arrange that tension (or path length) remains within predetermined limits.

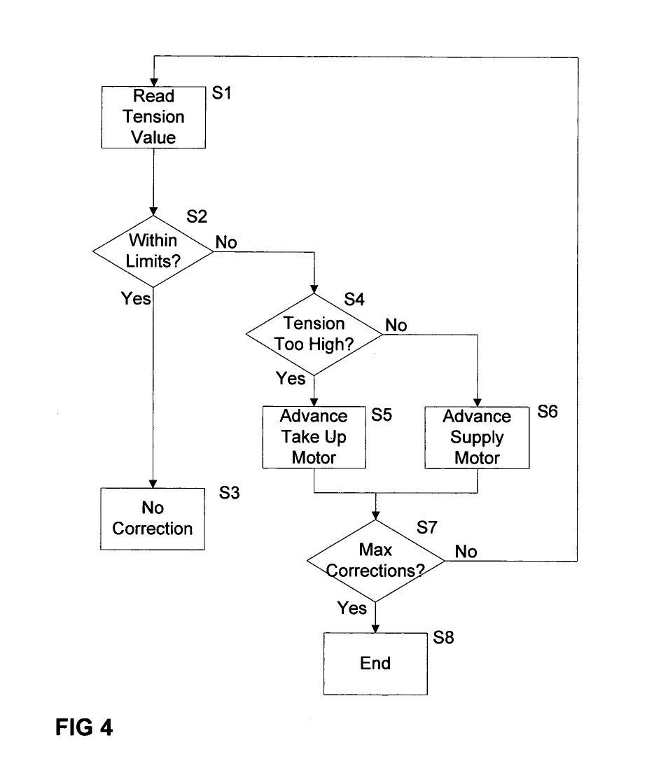

A method for controlling the supply motor 12 and the takeup motor 13 in response to monitored tension is now described with reference to FIG. 4. The method is described with reference to monitoring tension in the tape being transported which can be carried out using the embodiments of FIG. 1 or 2. It will however be appreciated that the method is similarly applicable to a method concerned with monitoring of path length.

Referring to FIG. 4, at step S1 a tension value is obtained from a tension sensor. At step S2 a check is made to determine whether the read tension value is between predetermined limits. If tension is between predetermined limits, no action is required, and processing therefore passes to step S3. If however tension is outside predetermined limits, processing passes to step S4 where a check is made to determine whether tension is too high or too low. If tension is too high processing passes to step S5, where the supply motor 12 is controlled to advance by a predetermined number of motor steps. If tension is too low, processing passes to step S6, where the takeup motor 13 is controlled to advance by a predetermined number of motor steps. Processing passes from either of steps S5 and S6 to step S7 where a check is carried out to determine whether a number of iterations carried out (each iteration representing a correction) is equal to a maximum number of allowed iterations, which may be three iterations. If this is the case, processing ends at step S8. If the maximum number of allowed iterations has not been carried out processing returns to step S1 and continues in the manner described above.

The processing of FIG. 4 is such that the motors are controlled to iteratively correct tension in the tape so as to bring that the tension between predetermined limits.

In alternative embodiments of the invention, the predetermined number of steps through which the motors are turned may be varied based upon the diameter of the relevant spool. In such a case, it will be appreciated that the corrections of steps S5 and S6 provide an iterative correction by adding or subtracting a predetermined length of tape to or from tape extending between the spools 3, 4.

The processing described above with reference to FIG. 4 can be carried out at any convenient time during operation of the printing apparatus. In one embodiment, the processing is carried out between two printing operations. That is, tension in the tape is monitored while the tape is stationary, and any necessary correction is achieved before a subsequent printing operation is carried out.

Further modifications and applications of the present invention will be readily apparent to the appropriately skilled person from the teaching herein, without departing from the scope of the appended claims.

1. A printing apparatus configured to carryout a plurality of printing operations, the apparatus comprising:
a tape drive comprising two motors, two tape spool supports on which spools of tape may be mounted, each spool being drivable by a respective one of said motors, and a controller for controlling the energisation of the motors such that the tape may be transported in at least one direction between spools mounted on the spool supports, wherein the controller is configured to:
(a) receive a signal indicative of a value of a characteristic of said tape, the characteristic being affected by operation of the tape drive;
(b) determine whether said value satisfies a predetermined criterion; and
(c) if said value does not satisfy said predetermined criterion, to provide a predetermined control signal, said predetermined control signal being configured to affect said characteristic of said tape.

2. A printing apparatus according to claim 1, wherein said controller is configured to carry out steps (a) to (c) a plurality of times.

3. A printing apparatus according to claim 2, wherein said controller is configured to carry out steps (a) to (c) until said value satisfies said predetermined criterion.

4. A printing apparatus according to claim 1, wherein said controller is configured to carry out steps (a) to (c) not more than a predetermined plurality of times.

5. A printing apparatus according to claim 1, wherein said controller is configured to carry out steps (a) to (c) for not more than a predetermined period.

6. A printing apparatus according to claim 1, wherein said controller is configured to carry out steps (a) to (c) a plurality of times between two successive printing operations.

7. A printing apparatus according to claim 1, further comprising a sensor configured to generate said signal.

8. A printing apparatus according to claim 7, wherein said sensor comprises a deflectable element deflectable by said tape, and said signal is generated based upon deflection of said deflectable element.

9. A printing apparatus according to claim 8, wherein said sensor further comprises a Hall effect sensor, said deflectable element is provided with at least one magnetic element and deflection of said deflectable element is monitored based upon an effect of said at least one magnetic element on said Hall effect sensor.

10. A printing apparatus according to claim 8, wherein said sensor further comprises at least one switch, and said signal is generated based upon activation of said at least one switch.

11. A printing apparatus according to claim 10, wherein said sensor further comprises a plurality of switches, and said signal is generated based upon activation of said plurality of switches.

12. A printing apparatus according to claim 8, wherein said sensor further comprises an encoder, and said encoder is configured to provide an output indicating a degree of deflection of said deflectable element.

13. A printing apparatus according to claim 1, wherein said characteristic of said tape is tension in said tape.

14. A printing apparatus according to claim 7, wherein said sensor comprises a loadcell.

15. A printing apparatus according to claim 1, wherein said characteristic of said tape is a length of a tape path between said spools.

16. A printing apparatus according to claim 1, wherein at least one of said motors is a position controlled motor.

17. A printing apparatus according to claim 16, wherein at least one of said motors is a stepper motor.

18. A printing apparatus according to claim 17, wherein said predetermined control signal controls at least one of said motors to turn through a predetermined number of steps.

19. A printing apparatus according to claim 1, wherein said predetermined control signal controls at least one of said motors to add or subtract a predetermined length of tape to or from tape extending between the spools.

20. A printing apparatus according to claim 19, further comprising means to calculate a number of steps through which at least one of said motors is to be turned to add or subtract said predetermined length.

21. A printing apparatus according to claim 1, wherein the controller is operative to energise both motors to drive the spools of tape in the direction of tape transport.

22. A printing apparatus according to claim 1, wherein said controller is configured to maintain tension in tape between said spools between predetermined limits.

23. A printing apparatus according to claim 1, wherein the controller is arranged to control the motors to transport tape in both directions between the spools.

24. A printing apparatus according to claim 1, wherein the printing apparatus is a thermal transfer printing apparatus.

25. A printing apparatus according to claim 1, wherein said tape drive is configured to transport inked tape between said spools, the apparatus comprising a printhead configured to contact said tape between said spools.

26. A method for controlling a printing apparatus configured to carryout a plurality of printing operations, the apparatus comprising a tape drive comprising two motors, two tape spool supports on which spools of tape may be mounted, each spool being drivable by a respective one of said motors, and a controller for controlling the energisation of the motors such that the tape may be transported in at least one direction between spools mounted on the spool supports, wherein the controller:
(a) receives a signal indicative of a value of a characteristic of said tape, the characteristic being affected by operation of the tape drive;
(b) determines whether said value satisfies a predetermined criterion; and
(c) if said value does not satisfy said predetermined criterion, provides a predetermined control signal, said predetermined control signal being configured to affect said characteristic of said tape.
